(19) United States
(12) Patent Application Publication
(10) Pub. No.: US 2025/0134178 A1
(43) Pub. Date: May 1, 2025

(54) AEROSOL PROVISION SYSTEMS

(71) Applicant: NICOVENTURES TRADING LIMITED, London (GB)

(72) Inventor: Jeremy CAMPBELL, London (GB)

(21) Appl. No.: 18/730,502

(22) PCT Filed: Jan. 18, 2023
(86) PCT No.: PCT/GB2023/050084

§ 371 Date: Jul. 19, 2024

(30) Foreign Application Priority Data
Jan. 21, 2022 (GB) 2200777.7

(51) Int. Cl. A24F 40/57; A24F 40/53

(52) U.S. Cl. CPC A24F 40/57; A24F 40/53

(57) ABSTRACT

An aerosol delivery system configured to heat a consumable part to generate an aerosol, the aerosol delivery system comprising a controller configured to: initiate heating of the consumable part; monitor, during heating of the consumable part, a parameter associated with an amount of user inhalation on the consumable part over a plurality of puffs; and stop heating the consumable part based on the parameter associated with an amount of user inhalation.

### FIELD

The present disclosure relates to aerosol provision systems.

### BACKGROUND

Aerosol provision/delivery systems generally contain an aerosol generating material, such as a portion of a solid, liquid or gel, or a reservoir of a source liquid, and/or which may contain an active substance and/or a flavour, from which an aerosol or vapour is generated for inhalation by a user, for example through heat vaporisation. Thus, an aerosol provision system/electrical smoking system will typically comprise a heating chamber or aerosol generation chamber containing an aerosol generator, e.g. a heating element, arranged to vaporise or aerosolise a portion of aerosolisable material (e.g. a solid material such as tobacco) to generate a vapour or aerosol in the aerosol generation chamber. As a user inhales on the device, and electrical power is supplied to the heating element, air is drawn into the device through an inlet hole and along an inlet air channel connecting to the aerosol generation chamber where the air mixes with vaporised precursor material to form a condensation aerosol. An outlet air channel connects from the aerosol generation chamber to an outlet in the mouthpiece, and the air drawn into the aerosol generation chamber as a user inhales on the mouthpiece continues along the outlet flow path to the mouthpiece outlet, carrying the aerosol with it, for inhalation by the user. Some aerosol provision systems may also include a flavour element in the air flow path through the device to impart additional flavours. Such devices may sometimes be referred to as hybrid devices, and the flavour element may, for example, include a portion of solid aerosol-generating and/or flavourant material such as tobacco arranged in the air flow path between the aerosol generation chamber and the mouthpiece such that aerosol/condensation aerosol drawn through the device passes through the portion of solid material before exiting the mouthpiece for user inhalation. In some aerosol provision systems, the aerosol generating material comprises a source liquid comprised in a cartridge or pod which also contains the heating element and aerosol generating chamber, and the cartridge is mechanically and electrically coupled to a control unit for use. The control unit comprises a battery and control circuitry which together supply power to the heating element via the cartridge.

In some contexts, energy delivery to aerosolise aerosol generating material in an aerosol provision/delivery system is configured according to a target heating time for the aerosol generating material in the aerosol delivery device. For example, a heating time may be predefined in manufacture or set by the user. When heating of an article comprising aerosol generating material is initiated, a timer comprised in control circuitry of the aerosol delivery device counts elapsed heating time, and the control circuitry is configured to stop heating of the aerosol generating material when the predefined heating time has elapsed.

The inventors have recognised that it may be advantageous to control the time for heating of an article comprising aerosol generating material in a

### SUMMARY

According to a first aspect of the present disclosure, there is provided an aerosol delivery system configured to heat a consumable part to generate an aerosol, the aerosol delivery system comprising a controller configured to: initiate heating of the consumable part; monitor, during heating of the consumable part, a parameter associated with an amount of user inhalation on the consumable part over a plurality of puffs; and stop heating the consumable part based on the parameter associated with an amount of user inhalation.

According to a second aspect of the present disclosure, there is provided an aerosol delivery device configured to heat a consumable part to generate an aerosol, the aerosol delivery device comprising a controller configured to: initiate heating of the consumable part; monitor, during heating of the consumable part, a parameter associated with an amount of user inhalation on the consumable part over a plurality of puffs; and stop heating the consumable part based on the parameter associated with an amount of user inhalation.

According to a third aspect of the present disclosure, there is provided a method of controlling an aerosol delivery system, comprising a controller, to heat a consumable part to generate an aerosol, the method comprising operating the controller to carry out the steps of: initiating heating of the consumable part; monitoring, during heating of the consumable part, a parameter associated with an amount of user inhalation on the consumable part over a plurality of puffs; and stopping heating the consumable part when the parameter reaches a threshold.

According to a fourth aspect of the present disclosure, there is provided a computer readable storage medium comprising instructions which, when executed by a processor, performs a method according to the third aspect.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

Embodiments of the disclosure will now be described, by way of example only, with reference to the accompanying drawings, in which:

FIG. 1 is a schematic diagram of an aerosol provision device in accordance with some embodiments of the disclosure.

FIG. 2 is a flowchart setting out aspects of operation of an aerosol delivery system according to the present disclosure.

FIG. 3 is a schematic diagram showing monitoring of an airflow rate for a plurality of puffs.

FIG. 4 is a schematic diagram showing an approach for establishing a heating duration on the basis of integrating airflow rate for a plurality of puffs.

FIG. 5 is a schematic diagram showing monitoring of a heater or consumable temperature for a plurality of puffs.

FIG. 6 is a schematic diagram showing an approach for establishing a heating duration on the basis of integrating a heater or consumable temperature for a plurality of puffs.

FIG. 7 is a schematic diagram showing an approach for modifying a predefined heating duration on the basis of a user inhalation parameter.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision/delivery systems/devices (which may also be referred to as vapour delivery systems/devices). Throughout the following description the terms “electrical smoking system”, “heat-not-burn” system, or “tobacco heating product” may sometimes be used, but it will be appreciated these terms may be used interchangeably with aerosol provision/delivery system/device and electronic aerosol provision/delivery system/device. Furthermore, and as is common in the technical field, the terms “aerosol” and “vapour”, and related terms such as “vaporise”, “volatilise” and “aerosolise”, may generally be used interchangeably.

Aerosol provision systems often, though not always, comprise a modular assembly including both a reusable ‘device’ part and a replaceable ‘consumable’ part. Typically the replaceable consumable part will comprise an aerosol generating material to be heated to generate aerosol, and the reusable part will comprise a power supply (e.g. rechargeable power source), control circuitry, and a heater configured to heat the aerosol generating material in the consumable part when it is coupled to the reusable part. In such embodiments, heat is generally transferred from a heater in the reusable device part into a portion of the consumable part to aerosolise/vaporise aerosol generating material in a heated portion of the consumable part, or electrical power or a magnetic field is transmitted into the consumable part to cause an aerosol generator in the consumable part to generate aerosol from the aerosol generating material. Accordingly, the consumable part in some cases comprises elements associated with heating of the aerosol generating material in the consumable part. For example, the consumable part may comprise a susceptor which may be inductively heated by a magnetic field generator/drive coil arrangement in the reusable device part in order to aerosolise the aerosol generating material in the consumable part, and/or the consumable part may comprise a heating element which receives electrical power from the reusable device part via an electrical interface between the reusable device part and the consumable part when the consumable part and reusable device part are coupled together for use. The consumable part may be configured to be partially or fully inserted into the reusable device part for use, for example, by inserting it into a chamber/receiving recess of the reusable device part which may comprise an aerosol generation chamber or heating chamber situated within the housing of the reusable device part. Such a chamber may be accessed via an aperture/opening disposed in the outer casing of the reusable device part. When the aerosol generating material in a given consumable part is exhausted, or the user wishes to switch to a different consumable part having a different aerosol generating material, the consumable part may be removed from the reusable device part by retracting it from the chamber via the aperture, and a replacement consumable part can be coupled to the reusable device part in its place. Devices conforming to this type of two-part modular configuration may generally be referred to as ‘two-part’ devices.

It is common for aerosol provision systems/devices (and reusable device parts and consumable parts comprising them) to have a generally elongate shape. For the sake of providing a concrete example, certain embodiments of the disclosure described herein will be taken to comprise this kind of generally elongate two-part device employing a reusable device part comprising a heater, and a consumable comprising aerosol generating material. However, it will be appreciated the underlying principles described herein may equally be adopted for different aerosol provision system configurations, for example single-part devices or modular devices comprising more than two parts, refillable devices and single-use disposable devices, as well as devices conforming to other overall shapes, for example based on so-called ‘box-mod’ high performance devices that typically have a more boxy shape, and so-called ‘pod-mod’ devices which generally comprise a cartridge containing a heater and a supply of aerosol generating material, often in the form of a liquid, which is partially inserted into a chamber in a reusable device part to establish an electrical connection between the cartridge and control circuitry of the reusable device part via abutment of electrical contacts on the cartridge and electrical contacts disposed within the chamber of the reusable device part, when the cartridge is received in the chamber. More generally, it will be appreciated certain embodiments of the present disclosure are based on aerosol provision systems which are operationally configured to provide functionality in accordance with the principles described herein and the constructional aspects of the aerosol provision systems configured to provide the functionality in accordance with certain embodiments of the disclosure is not of primary significance.

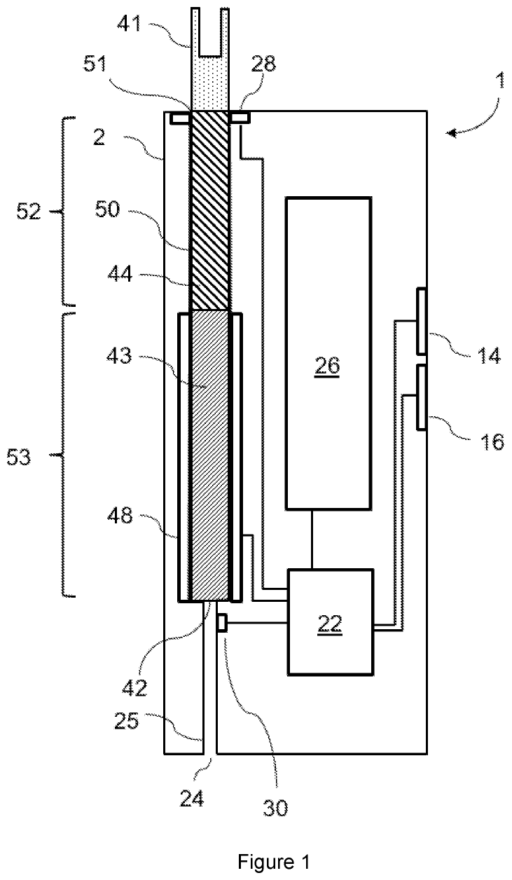

FIG. 1 is a cross-sectional view through an example aerosol provision system/heat-not-burn device 1 in accordance with certain embodiments of the disclosure. The aerosol provision system 1 comprises two main components, namely a reusable device part 2 and a replaceable consumable/cartridge/cartomiser part, which comprises aerosol generating material 43, an air inlet 42, an air outlet (for example comprised in a mouthpiece 41), and may comprise any of a filter/cooling element 44.

In normal use the reusable part 2 and the consumable part are releasably coupled/attached together by partially or fully inserting the consumable part into a chamber 50 of the reusable device part 2, comprising a heater chamber region/heating region 53. The chamber 50 may be considered a heating/heater chamber in the sense that the consumable part is configured to be heated by the reusable device part 2 whilst at least partially received in the chamber, by, for example, a heater comprised in the reusable part 2 heating the consumable part, or the reusable part 2 supplying energy (i.e. electrical energy) to the consumable part to cause heating of a heater comprised in the consumable part (e.g. by inductive heating). FIG. 1 schematically shows the reusable device part 2 with a consumable part partially received into a chamber 50. Chamber 50 comprises a cylindrical tube extending into the reusable device part 2 from an outer housing surface of the reusable device part. In this example, the chamber extends into the device from an outer surface of the mouthpiece end of the reusable device part 2, defined as the uppermost part of the reusable device part as a user holds it in their hand for use, the chamber 50 extending parallel to the long axis of the reusable device part 2. An aperture 51 communicates between the chamber 50 and the exterior of the device. However, this arrangement for receiving a consumable part is exemplary, and other configurations known to the skilled person may be used (for example, a heater chamber may comprise an ‘oven’ accessed via a door, or accessed by separating two parts of reusable device part 2, into which a consumable part, or loose aerosol generating material may be introduced). More generally, the consumable may take other forms known to the skilled person, including, as described further herein, configurations where the aerosol generating material comprises liquid or gel.

In broad outline, the reusable device part 2 is configured to generate an aerosol to be inhaled by a user, typically by heating one or more aerosol generating materials in the consumable part, either directly via one or more heating elements associated with the heating region 53 of the chamber 50, or by transmitting electrical energy or a magnetic field into the consumable part to activate an aerosol generator such as an inductively heated heating element in or on the consumable part. In use, a user inserts a consumable part into the chamber 50 of the reusable device part via the aperture 51, and then activates the reusable device part 2 using a user input interface, for example comprising a button 14, to cause the reusable device part 2 to supply power from a power supply/battery 26 to an aerosol generating element 48 to aerosolise the aerosol generating material(s) comprised in the consumable part for inhalation by a user. The user subsequently draws on a mouthpiece 41 of the consumable part which extends out of the aperture 51 at the mouthpiece end of reusable device part 2 to inhale an aerosol generated in the consumable part. In the example of FIG. 1, as a user draws on the mouthpiece 41 of the consumable part, air is drawn into an air inlet 24 disposed on an outer surface of reusable part 2, down an air inlet channel 25, and into a heating region 53 of the chamber 50, wherein it enters at least one air inlet 42 of the consumable part, entraining vapour/aerosol generated via aerosolisation/heating of a portion of aerosol generating material 43 comprised in the consumable part. In other embodiments, air directly enters the air inlet 42 of the consumable part without passing through the reusable device part 2. For the same of a concrete example, FIG. 1 shows schematically a heating element 48 arranged around the heating region 53 of the chamber 50 as described further herein, which transmits heat into a portion of the consumable part containing aerosol generating material 43. The entrained vapour/aerosol travels through the consumable part towards a mouthpiece end of the reusable device part 2 (from which a mouthpiece 41 of consumable part extends), wherein aerosol droplets condense out or further condense out of the vapour/aerosol in a cooling region 44, forming a condensation aerosol which exits the mouthpiece 41 of the consumable part for inhalation by the user.

The reusable part 2 comprises an outer housing having with an opening that defines an air inlet 24, a power source 26 (for example a battery) for providing operating power for the aerosol provision system, control circuitry 22 for controlling and monitoring the operation of the aerosol provision system, an optional user input button 14, an optional display 16, and an optional visual display/visual indicator 28. The outer housing of the reusable device part 2 may be formed, for example, from a plastics or metallic material, or any other material known to the skilled person. For the sake of providing a concrete example, the reusable device part 2 may in some embodiments have a length of around 80 mm, and the consumable part extends from the mouthpiece end of the reusable device part by approximately 10 to 30 mm when inserted into the chamber 50, so the overall length of the aerosol provision system 1 when the consumable part and reusable device part are coupled together is around 90 to 110 mm. The consumable part may have a diameter of approximately 80 mm. However, and as already noted, it will be appreciated that the overall shape and scale of an aerosol provision system implementing an embodiment of the disclosure is not significant to the principles described herein.

The power source 26 in this example is rechargeable and may be of a conventional type, for example of the kind normally used in aerosol provision systems such as heat-not-burn devices, tobacco heating devices, electronic cigarettes and other applications requiring provision of relatively high currents over relatively short periods (for example, a lithium ion battery). The power source 26 may be recharged through a charging connector (not shown) in the reusable part housing, comprising for example a micro-USB or USB-C connector, which may also provide an interface for data transfer between a controller 22 and an external processing device such as a smartphone or a personal computer.

A user input button 14 may optionally be provided, which in this example is a conventional mechanical button, for example comprising a spring mounted component which may be pressed by a user to establish an electrical contact. In this regard, the input button 14 may be considered an input devices for detecting user input and the specific manner in which the button is implemented is not significant (e.g. it may comprise a capacitive touch sensor and/or a touch-sensitive display element). A plurality of such buttons may be provided, with one or more buttons being assigned to functions such as switching the aerosol provision system 1 on and off, and adjusting user settings such as a power to be supplied from the power source 26 to an aerosol generator 48, a heating period for a consumable part, and/or selection one or more device modes. However, the inclusion of user input buttons is optional, and in some embodiments such buttons may not be included.

An optional display unit 16 may in some instanced be provided on an outer surface of the housing of reusable device part 2. The display unit 16, where included, may comprise a pixilated or non-pixilated display unit (for example, comprising a single LED, an array of LEDs, a liquid crystal display (LCD), light-emitting diode (LED) display, organic light emitting-diode (OLED) display, active-matrix organic light-emitting diode (AMOLED) display, electroluminescent display (ELD), plasma display panel (PDP), e-ink display), connected to controller 22. The skilled person may implement such a display in accordance with any approaches known in the art. Such a display may be used for displaying to a user usage information about the use of the aerosol provision system 1. Exemplary forms of usage information which may be displayed to a user via an optional display unit 16 are described further herein. A display may comprise integrated user input functionality (e.g. the display may comprise a touch-screen display unit), and in such embodiments separate user input button(s) 14 may be omitted.

At least one visual indicator/visual feedback indicator 28 may provided, which may be in addition to or instead of a display 16, the visual indicator comprising a display region visible on an outer surface of the housing of the reusable device part 2, the visual indicator 28 being configured to provide visual feedback to a user about one or more aspects of the operation or status of the device. Such visual feedback may comprise information about, for example, whether the system is on or off, a selected operating mode, how much charge or aerosol generating material remains in the system, the temperature of a heating element, or a strength with which a user is inhaling on the device (e.g. derived from an airflow sensor as described further herein), or information relating to a heating period of a consumable part, such as a remaining heating time, or a change to an existing remaining heating time. Such information may be shown before, during and/or after a puff or session on the aerosol provision device. The visual indicator used to display such information may comprise a display panel comprising a plurality of pixels, comprising for example an LCD, LED, OLED, AMOLED, ELD, PDP, e-ink display, or any other form of pixilated display panel known to the skilled person. Additionally or alternatively, the visual indicator 28 may comprise one or more non-pixilated display elements, such as one or more LEDs. Where the visual indicator 28 comprises one or more LEDs, the colour of each LED may be selected from among a set of LED colours known to the skilled person, and/or LEDs may be used which are configured to show more than one colour (e.g. one or more RGB LEDs may be used).

A controller 22 is suitably configured/programmed to control the operation of the aerosol provision system to provide functionality in accordance with embodiments of the disclosure as described further herein, as well as for providing conventional operating functions of the aerosol provision system in line with the established techniques for controlling such devices. The controller (processor circuitry) 22 may be considered to logically comprise various sub-units/circuitry elements associated with different aspects of the operation of the aerosol provision system 1. In this example the controller 22 comprises power supply control circuitry for controlling the supply of power from the power source 26 to the aerosol generator 48 in response to user input, user programming circuitry for establishing configuration settings (e.g. user-defined power settings) in response to user input, as well as other functional units/circuitry associated functionality in accordance with the principles described herein and conventional operating aspects of aerosol provision systems, such as display driving circuitry and user input detection circuitry. It will be appreciated the functionality of the controller 22 can be provided in various different ways, for example using one or more suitably programmed programmable computer(s) and/or one or more suitably configured application-specific integrated circuit(s)/circuitry/chip(s)/chipset(s) configured to provide the desired functionality. The controller 22 may comprise a wireless transceiver and associated control circuitry enabling transfer of data between the reusable device part 2 and an external computing device such as a smartphone or personal computer (not shown), via a wireless transfer protocol such as Bluetooth, near-field communication (NFC) or Zigbee. The controller 22 also comprises one or more data storage elements (e.g. a memory element such as a ROM or RAM element) which can be used to store data associated with usage of the aerosol provision system, according to established techniques for data storage and transfer. Throughout the present disclosure, it will be appreciated that when operations are referred to in which (i) user inputs such as selection of parameters and device modes are provided to a user input interface of the reusable device part 2, (ii) information is displayed to a user on a display of the reusable device part 2, and (iii) information is processed by a controller 22 (for example relating to determination of a heating time for a consumable), one or more of these functions may be carried out by an external electronic device (e.g. a smartphone, a refill/charging dock or case, a personal computer (PC), a wearable device (e.g. a smart watch) or a server) to which the aerosol provision system is configured to connect via a wired or wireless communication protocol using a wired or wireless data interface between the aerosol delivery system 1 and the external electronic device. Thus a wireless transceiver integrated in controller 22 may comprise a Bluetooth, ZigBee, WiFi, Wifi Direct, GSM, 2G, 3G, 4G, 5G, LTE, NFC or RFID module, or any other wireless communications module known to the skilled person, and/or a wired interface such as USB-C, micro-USB, Thunderbolt or other wired interface. Thus user inputs provided on a an external electronic device (e.g. a smartphone) may be transmitted to controller 22 of the aerosol delivery device to control any aspect of operation of the aerosol delivery device 1 as set out herein. Processing of information/data may be carried out via a processor/controller of an external electronic device (e.g. a smartphone), based on information transmitted to the external electronic device by the controller 22, with processed information/data, or control parameters based on such processing, being transmitted back to controller 22, to enable controller 22 to modify the operation of the aerosol delivery system on the basis of the data/parameters. Provision of visual, audible, or haptic notifications/indications to the user relating to operation of the aerosol delivery system as set out herein may be provided by an external electronic device (e.g. a smartphone) based on indication-related information/data transmitted to the external electronic device by the controller 22. Thus in general, any functionality described herein relating to user inputs, data processing, and provision of indications to a user, may be ‘offloaded’ to an external electronic device via a wired or wireless data connection, in a similar manner to that in which devices/computing nodes distributed over a wired or wireless computing network may transmit data between them to distribute functionality of the system between different devices/nodes.

The reusable device part comprises means to infer a rate of aerosolisation of aerosol generating material (which may also be considered to be a rate of depletion of the aerosol generating material 44 as the aerosol generating system 1 is used) by monitoring a parameter associated with an amount of user inhalation on the consumable part over a session comprising a plurality of puffs. This may be achieved by monitoring measurements of, for example, airflow through the consumable part, a temperature of the consumable part, a level of power supplied to heat the consumable part, and/or a time of heating of the consumable part, as described further herein. Thus, in some embodiments of the present disclosure, reusable device part 2 may comprise an airflow sensor 30 such as a pressure sensor (e.g. a MEMS pressure sensor) or flow-rate sensor (for example a microphone or hot-wire anemometer) which is electrically connected to the controller 22, and in fluid communication with a portion of the airflow path between air inlet 24 and mouthpiece 41. The airflow sensor 30 may, for example, be disposed in a wall of the air inlet channel 25 or the chamber 50, and/or extend at least partially into or across a portion of an air flow pathway defined by air inlet channel 25 or the chamber 50). In some embodiments, a combined airflow and temperature sensor is used which allows the temperature of airflow in a portion of the airflow path in the device to be determined. In some embodiments, the airflow sensor comprises a so-called “puff sensor”, in that a signal from the airflow sensor 30 is used by the controller 22 to detect when a user is puffing on the device, and optionally the strength of the puff as indicated by pressure and/or airflow speed. In some embodiments, detection of a user puff (for example, by the controller 22 determining that a signal from the airflow sensor 30 indicative of pressure and/or flow rate in the airflow path between air inlet 24 and the mouthpiece 41, is above a predefined threshold) is used by the controller 22 to initiate heating by controlling the supply of power to the aerosol generator/heater 48. In other words, the heater/device may be considered to be ‘puff-activated’. Accordingly, the controller 22 may distribute electrical power from the power source 26 to the aerosol generator 48 in dependence on at least a signal received from the airflow sensor 30 by the controller 22. In other embodiments, the supply of power to the aerosol generator 48 is initiated via other means (e.g. by detecting user input on a button 14 or touch-screen display 16; or by detecting via a suitable sensor, comprising for example a mechanical switch or capacitive sensor associated with the chamber 50, that a consumable part has been received in the chamber). It will be appreciated that the inclusion of an airflow sensor is optional, and in some embodiments no airflow sensor is included, with information about the rate of aerosol generation being provided to the controller 22 in another way, as described further herein. 24. The controller 22 is configured to initiate heating of a consumable based on receiving a signal associated with user interaction with the device, which may comprise at least one of a signal from a user-input interface (e.g. button 14) indicating a user has provided a control input, a signal from an airflow sensor 30 comprised in the aerosol delivery system indicating a change in a rate of airflow through the aerosol delivery system, or a signal from a consumable sensor (not shown) comprised in the aerosol delivery system indicating a consumable has been coupled to the device.

In addition to or instead of using an airflow sensor to provide information relating to the rate of aerosolisation of the aerosol generating material 44 (e.g. a parameter associated with an amount of user inhalation on the consumable part) to the controller 22, such information may be provided by sensing/measuring/monitoring a temperature of the consumable part or inferring the temperature of the consumable part based on monitoring a temperature of the heater 48 while the consumable part is being heated. Where the aerosol generator 48 is configured to heat the consumable part, the temperature of part of the aerosol generator 48, and/or the heating region 53 of the chamber 50, or the consumable part, or any part of the reusable device part 2, may therefore be detected by the controller 22 using one or more temperature sensors (not shown), which may be separate to or integrated into the heater 48. In other embodiments, the heater 48 is configured to allow it to be used for sensing temperature. For example, a heating element comprised in aerosol generator 48 may comprise a material with a temperature coefficient of resistance property such that its resistance varies with temperature. The controller 22 may determine the resistance of the heating element 48 via known approaches (e.g. by using a reference resistor circuit to determine the voltage across the heater at a known current determined by voltage measurement across a current-sense resistor), and looking up the heater resistance in a look-up table derived via experimentation or modelling linking heating element resistance to temperature, in order to estimate a temperature of the aerosol generator 48 based on the measured resistance. Alternatively or in addition, one or more temperature sensing elements such as thermistors may be positioned in the vicinity of the heating region 53 (for example, attached to or embedded in a tube comprising the heating region 53 of the chamber 50), said thermistors being connected to the controller 22 to enable the controller to monitor the temperature of the consumable part and/or the heating region 53 or directly monitor the temperature of the heater 48. The temperature of air in the air inlet channel 25 may also be monitored by one or more temperature sensors (for example a combined temperature and pressure sensor or thermistor) in a similar manner. In some embodiments, an integrated pressure and temperature sensor is provided which can monitor parameters associated with an amount of user inhalation on the consumable part comprising both direct airflow and temperature measurements. In some embodiments, the parameter associated with an amount of user inhalation on the consumable part is a function, computed by the controller 22, of measurements of both temperature and airflow rate, as provided by separate or integrated pressure and temperature sensors. For example, the computed parameter may comprise a sum or product of measurements of parameters representing temperature and airflow rate respectively, which may be scaled by suitable coefficients established by the skilled person on the basis of experimentation and modelling. Experiments may be carried out to monitor temperature and airflow rate using the temperature and airflow sensors during heating of a consumable part over a plurality of puffs, whilst separately measuring via aerosol analysis apparatus the rate of aerosol generation from the device. A function of the temperature and airflow rate may be fitted to the aerosol generation rate profile, to obtain a fitted function which describes the aerosol generation rate in terms of temperature and airflow rate (or any single one of these parameters). It will be appreciated that the parameter may be a discrete parameter/variable (such as, for example, a cumulative number of puffs in a session/since initiating heating of the consumable part), or a continuous parameter/parameter representing a continuous variable (such as, for example, the instantaneous or integrated airflow rate through the aerosol delivery system, or a parameter relating to a temperature of a consumable part/heating element, or a level of power delivered to a heating element, as described further herein). In some embodiments, the parameter is a continuous parameter representing the cumulative inhalation time, as determined on the basis of detecting airflow through the aerosol delivery system/consumable part (using airflow detection/measurement approaches described further herein). In some embodiments, the parameter associated with an amount of user inhalation on the consumable part over a plurality of puffs comprises the discrete number of puffs, comprising a plurality of puffs, taken since initiating heating of the consumable part.

In some embodiments, the aperture 51 of the reusable part 2 via which the consumable part is inserted into the chamber 50 may be opened and closed by a door (not shown), which is movable between a closed position and an open position to allow for insertion of the consumable part into the reusable device part 2 when in the open position. The door may be co-planar with a mouthpiece-end surface of the reusable device part, being configured slide along an axis between open and closed positions or rotate between open and closed positions. A spring or magnet may bias the door the open and closed positions to retain it in either of the open or closed position once the user has slid or rotated the door into either position.

As described further herein, the reusable part 2 typically comprises an aerosol generator 48 located in the vicinity of the heating region 53 of the consumable chamber 50. As set out in embodiments of the disclosure, an aerosol generator is an element or apparatus configured to cause aerosol to be generated from the aerosol-generating material in the consumable part, for example, by heating. Accordingly, in some embodiments, the aerosol generator 48 comprises a heater configured to subject the aerosol-generating material in the consumable part to heat energy, so as to release one or more volatiles from the aerosol-generating material to form an aerosol. In some embodiments, the aerosol generator is configured to cause an aerosol to be generated from the aerosol-generating material without heating. For example, the aerosol generator 48 may be configured to subject the aerosol-generating material in the consumable part to one or more of vibration, increased pressure, or electrostatic energy to volatilise the aerosol generating material. It will be appreciated that in a two-part device such as shown in FIG. 1, portions of the aerosol generator 48 may be in either of the reusable device part 2 and/or the consumable part. It will further be appreciated that in some instances the consumable part may comprise a cartridge containing an electrically operated aerosol generator (e.g. a heater), and that in addition to or in place of aerosol generator 48 in the reusable device part 2, the reusable device part 2 may comprise an electrical interface comprising electrical contacts disposed in chamber 50 which electrically connect the aerosol generator in the consumable part with the power source 26 and controller 22 in the reusable device part when the consumable part is fully or partially received within the chamber 50.

In some embodiments of the disclosure, an aerosol generator 48 comprising at least one heating element is formed as a cylindrical tube, having a hollow interior heating chamber, configured in use to provide heat energy to a heating region 53 of the chamber/receiving recess 50, into which the consumable part comprising aerosol generating material 43 is inserted for heating. As set out further herein, a heating element may directly form a portion of a tube comprising chamber 50, or may be disposed around or proximate a heating region 53 of a tube comprising chamber 50. Different arrangements for the aerosol generator/heater 48 are possible. In some embodiments, a heater 48 may comprise a single heating element (e.g. a resistive trace, track and/or winding) or may be formed of plural heating elements aligned longitudinally or transversely (e.g. radially) to the longitudinal axis of the chamber 50. Each of one or more heating elements comprised in the heater 48 may be annular or tubular, or at least part-annular or part-tubular around its circumference. The one or more heating elements may comprise one or more thin-film heaters comprising one or more resistive tracks on a heat-resistant substrate comprising, for example, polyimide film. The one or more heating elements may comprise a ceramics material, comprising for example aluminium nitride or silicon nitride ceramics, which may be laminated and sintered with one or more heat-generating layers to form a heater according to approaches known in the art. Other heater arrangements are possible, including for example inductive heating elements, infrared heater elements, which heat by emitting infrared radiation, or resistive heating elements formed by for example a resistive electrical winding. In the latter case, the resistive winding may be disposed around a ceramic, metallic or heat-resistant polymer tube, or embedded within such a tube, the tube either comprising heating region 53 of the chamber 50, or arranged around it, to emit heat into a cavity within heating region 53. The battery 26 is electrically coupled to the heating element to supply electrical power when required, and under control of the control circuitry 22 to heat the aerosolisable material in the consumable (as discussed further herein, to volatilise the aerosolisable material without causing the aerosolisable material to burn).

In some embodiments, at least one heating element comprised in aerosol generator 48 is supported by and surrounds a thermally conductive tube, formed for example of stainless steel, comprising part of the wall of the chamber 50 which receives at least part of the consumable part. At least the portion of the tube proximate to the heating element(s) may be considered to comprise the heating region 53 of the chamber 50. The internal diameter of the tube comprising the chamber 50 is sized relative to the diameter of the consumable part to be inserted into the tube. The tube may taper slightly (not shown) from a wider diameter at the aperture 51 to a narrower diameter at the base of the chamber distal to the aperture 51, such that as the consumable part is slid into the chamber 50, the end distal to the mouthpiece 41 is slightly radially compressed as the consumable part reaches the end of its travel into the chamber 50, causing the consumable part to be gently retained in the chamber 50. This arrangement can prevent the consumable accidentally sliding out of the reusable device part if, for example, the reusable device part is inverted during use. The chamber 50 may also be slightly flared or chamfered at the aperture end to allow the consumable part to be easily guided into the chamber 50. Accordingly, the chamber 50 may act as an elongate support for supporting, in use, the consumable part comprising aerosol generating material. The diameter of the chamber 50 in the heating region 53 will in general be selected to closely match that of the consumable part, ensuring contact between the exterior surface of the consumable part and a substantial portion of the interior surface of the heating region 53 of the chamber 50, allowing for efficient heat transfer of heat from one or more heating elements comprised in the aerosol generator 48 into the consumable part.

In embodiments where the aerosol generator 48 comprises a heater, the tube comprising the heating region 53 of the chamber 50 comprises a material which transfers heat from the heater 48, to the consumable part, and generally comprises a metal or a metal alloy, such as one or more materials selected from the group consisting of: aluminium, gold, iron, nickel, cobalt, conductive carbon, graphite, steel, plain-carbon steel, mild steel, ferritic stainless steel, molybdenum, copper, and bronze. In other embodiments, the section of tube comprising the heating region 53 of the chamber 50 may be made from a different material, as long as it is thermally conductive. Other heating elements 48 may be used in other embodiments. For example, the heating element 48 may comprise a susceptor (for instance a portion of a tube comprising chamber 50) that is heated via induction when exposed to a magnetic field generated by one or more magnetic field generators such as drive coils (not shown) disposed within the reusable part 2.

Typically, where the aerosol generator 48 comprises one or more heating elements, the aerosol generator 48 is dimensioned relative to the distribution of aerosol generating material in the consumable part so that when the consumable is inserted in the reusable device part 2, substantially all of aerosol generating material in the consumable part can be heated in use (for example, a longitudinal extent of the heating region 53 down the axis of the chamber 50 may match the longitudinal extent of the distribution of aerosol generating material 43 in the consumable part, when the consumable part is received into the chamber 50 for use). In some embodiments, one or more heating elements comprised in the aerosol generator 48 may be arranged so that selected zones/regions of the aerosol generating material in the consumable part can be independently heated, for example in turn (over time) or together (simultaneously) as desired (for example by distributing independently controllable heating elements along a length of the chamber 50 comprising the heating region 53).

As mentioned further herein, in some embodiments, the aerosol generator 48 is in the form of a hollow cylindrical tube which comprises, is embedded in, or surrounds the heating region 53 of the chamber 50. The chamber formed by the internal portion of the tube comprising the heating region 53 is typically in fluid communication with the aperture 51 at the mouthpiece end of the reusable device part 2 via a non-heating region 52 of the chamber 50 (which may also be referred to as an expansions region/chamber. In such embodiments, the non-heating region 52 comprises a tubular body that has a first open end adjacent to or comprising the aperture 51 and a second open end adjacent the heating chamber region 53 of the chamber 50. In this manner, the non-heating region 52 and heating region 53 can be considered tubular portions of chamber 50 which are arranged end to end. In general, the diameter of the expansion region 52 and heating region 53 will be matched at the interface between them to ensure smooth passage of the non-mouthpiece end of the consumable part through the non-heating region 52 and into the heating region 53. The non-heating/expansion region 52 and heating region 53 of a tube comprising chamber 50 may be separately formed and connected via mechanical joining processes, or integrally formed. In some embodiments, the non-heating region 52 comprises a flared section (not shown) which widens as it opens out onto the aperture 51, and a section of substantially constant internal diameter proximate to the interface with the heating region 53.

In some embodiments, the consumable part is in the form of a cylindrical rod which has or contains aerosol generating material 43 at an end distal to the mouthpiece 41, in a section of the consumable part that is within the heating region 53 of the chamber 50 when the consumable part is inserted in the reusable device part 2. For the sake of providing a concrete example, in one embodiment the consumable part has a diameter of around 8 mm and a length of around 84 mm. The depth of the chamber 50 of the reusable device portion is sized relative to the length of the consumable part such that a mouthpiece end 41 of the consumable part typically extends from the aperture (for example, by 10 mm, 20 mm, 30 mm or more than 30 mm) when the consumable part is inserted into the chamber 50 for use. Accordingly, a mouthpiece end of the consumable part typically extends from the reusable device part 2, out of aperture 51. The consumable part may include a filter/cooling element 44 for filtering/cooling aerosol, disposed between the mouthpiece 41 and a region of aerosol generating material 43. The consumable part is typically circumferentially wrapped in a wrapper/outer layer (not shown) which may comprise a paper material, and/or a metallic foil, and/or a polymer film such as Natureflex™. The outer layer of the consumable part may be permeable to allow some heated volatilised components from the aerosol generating material 43 to escape the consumable part 2 prior to reaching the mouthpiece 41. In some embodiments, the wrapper may comprise a metallic material in the vicinity of the aerosol generating material 43, which is configured to act as a susceptor, which is heated by induction via one or more magnetic field generators/drive coils (not shown) in the reusable device part 2, so as to heat the aerosol generating material 43 via inductive heating. For example, in such embodiments, the aerosol generator 48 may comprise one or more magnetic field generators/drive coils configured to induce inductive heating of a metallic wrapper of consumable, and/or one or more susceptor elements embedded within the aerosol generating material 43 within the consumable part, to induce heating of aerosol generating material 43 in the consumable part. It will be appreciated the configuration of the consumable part set out above is illustrative, and the skilled person may modify the overall structure of the consumable part according to approaches known in the art.

In some embodiments, the aerosol generator 48 comprises at least one heating element configured to transfer heat into the consumable part (according to approaches for heating set out further herein), and at least one magnetic field generator/drive coil configured to inductively heat at least one susceptor element comprised in the consumable part (according to approaches set out further herein). In such embodiments, the aerosol generating material 43 may comprise a plurality of aerosol generating materials, at least a first of which is heated by heat transferred into the consumable part from the aerosol generator 48, and at least a second of which is heated by one or more susceptors comprised in or on consumable.

Typically, the primary flow path for heated volatilised components produced by heating of the aerosol generating material 43 by the heater 48 is axially through the consumable part, through the filter/cooling element 44 (where included), and into a user's mouth through the open end of the mouthpiece 41. However, some of the volatilised components may escape from the consumable part through its permeable outer wrapper and into a space surrounding the consumable part in the non-heated chamber region 52 (e.g. a space formed by an optional gap (not shown) between the outer surface of the consumable and the inner surface of the chamber 50 in the flared portion of the non-heating/expansion chamber region 53).

As used herein, the term “aerosol generating material” 43 typically includes materials that provide volatilised components upon heating, typically in the form of vapour or an aerosol. “Aerosol generating material” may be a non-tobacco-containing material or a tobacco-containing material. “Aerosol generating material” may, for example, include one or more of tobacco per se, tobacco derivatives, expanded tobacco, reconstituted tobacco, tobacco extract, homogenised tobacco or tobacco substitutes. The aerosol generating material can be in the form of ground tobacco, cut rag tobacco, extruded tobacco, reconstituted tobacco, reconstituted aerosol generating material, liquid, gel, amorphous solid, gelled sheet, powder, or agglomerates, or the like. “Aerosol generating material” also may include other, non-tobacco, products, which, depending on the product, may or may not contain nicotine. “Aerosol generating material” may comprise one or more humectants, such as glycerol, propylene glycol, triacetin, or diethylene glycol.

As noted above, the aerosol generating material 43 may comprise an “amorphous solid”, which may alternatively be referred to as a “monolithic solid” (i.e. non-fibrous), or as a “dried gel”. The amorphous solid is a solid material that may retain some fluid, such as liquid, within it. In some cases, the aerosol generating material comprises from about 50 wt %, 60 wt % or 70 wt % of amorphous solid, to about 90 wt %, 95 wt % or 100 wt % of amorphous solid. In some cases, the aerosol generating material consists of amorphous solid.

In some embodiments, the aerosol generating material is non-liquid aerosol generating material, and the reusable device part is for heating non-liquid aerosol generating material to volatilise at least one component of the aerosol generating material.

One or more active constituents/substances comprised in the consumable part may comprise one or more physiologically and/or olfactory active constituents which are included in the aerosolisable material in order to achieve a physiological and/or olfactory response in the user. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, cannabinoids, or mixtures thereof. Cannabinoids are a class of natural or synthetic chemical compounds which act on cannabinoid receptors (i.e., CB1 and CB2) in cells that repress neurotransmitter release in the brain. Two of the most important cannabinoids are tetrahydrocannabinol (THC) and cannabidiol (CBD). Cannabinoids may be naturally occurring (Phytocannabinoids) from plants such as cannabis, (endocannabinoids) from animals, and artificially manufactured (Synthetic cannabinoids). Cannabinoids are cyclic molecules exhibiting particular properties such as the ability to easily cross the blood-brain barrier, weak toxicity, and few side effects. Cannabis species express at least 85 different phytocannabinoids, and are divided into subclasses, including cannabigerols, cannabichromenes, cannabidiols, tetrahydrocannabinols, cannabinols and cannabinodiols, and other cannabinoids. such as cannabigerol (CBG), cannabichromene (CBC), cannabidiol (CBD), tetrahydrocannabinol (THC), cannabinol (CBN) and cannabinodiol (CBDL), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabinerolic acid, cannabidiolic acid (CBDA), Cannabinol propyl variant (CBNV), cannabitriol (CBO), tetrahydrocannabmolic acid (THCA), and tetrahydrocannabivarinic acid (THCV A).

Once all, or substantially all, of the volatilisable component(s) of the aerosol generating material in the consumable part have/have been exhausted, the user may remove the consumable part from the reusable device part 2 and dispose of the consumable part. The user may subsequently re-use the reusable device part 2 with another consumable part. However, in other respective embodiments, the consumable part and the reusable device part 2 may be disposed of together once the volatilisable component(s) of the aerosol generating material has/have been spent. The consumable part may be configured with a quantity of aerosol generating material 43 which is configured to be heated and exhausted over a single heating cycle (for example, an activation duration of 210 seconds), or may be configured with quantity of aerosol generating material 43 which is configured to be exhausted over a plurality of heating cycles. In the latter case, the consumable part may be considered to be a reusable consumable part.

In some embodiments, the consumable part may be sold, supplied or otherwise provided separately from the reusable device part 2 with which the consumable part is usable. However, in some embodiments, the reusable device part 2 and one or more of the consumable parts may be provided together as a system such as a kit or an assembly, possibly with additional components, such as cleaning utensils.

The inventors have recognised that it may be advantageous to allow a target time for heating of a consumable part comprising aerosol generating material to be modulated based on information relating to the rate of aerosolisation of the aerosol generating material and/or the rate of depletion of the aerosol generating material. In conventional smoking articles such as cigarettes, which generate aerosol by progressive combustion of aerosol generating material such as tobacco, the rate at which aerosol is generated, and at which the aerosol generating material is consumed/depleted by combustion is dependent on the rate of combustion. Where the combustion rate is increased, aerosol generation increases, and the time taken to deplete the aerosol generating material is concurrently reduced. The rate of combustion is a function, among other factors, of the rate of airflow through the smoking article. Hence a user of a conventional combustible smoking article who takes longer and deeper puffs may generally exhaust an individual smoking article more quickly than a user who takes comparatively shorter and shallowed puffs. The inventors have recognised that it may be desirable to control an electronic aerosol delivery device to provide a similar user experience in terms of the relationship between the duration of a heating cycle for a consumable, and the way in which the user puffs on the device. This may make the experience of using the electronic aerosol delivery device feel more similar to using a conventional smoking article, to support users who are seeking to transition from conventional smoking articles to an electronic aerosol delivery device.

Thus there is provided an aerosol delivery system configured to heat a consumable part to generate an aerosol, the aerosol delivery system comprising a controller configured to initiate heating of the consumable part; monitor, during heating of the consumable part, a parameter associated with an amount of user inhalation on the consumable part over a plurality of puffs; and stop heating the consumable part based on the parameter associated with an amount of user inhalation.

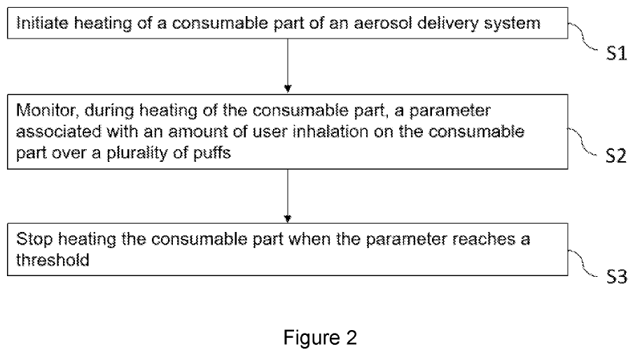

FIG. 2 shows a flowchart outlining an approach for operation of an aerosol delivery system according to the present disclosure, according to which, in a first step, S1, heating of a consumable part is initiated. In a second step, S2, a parameter associated with an amount of user inhalation on the consumable part is monitored during heating of the consumable part over a plurality of puffs. In a third step, S3, heating of the consumable part is stopped when the parameter reaches a threshold. In embodiments of the disclosure, the threshold is predefined.

Thus in embodiments of the present disclosure, having detected user input indicating a user wants to initiate a generation of aerosol from a consumable part according to approaches set out further herein (e.g. via puff detection, via detection of user input on a button or other user input interface, or via detection a consumable part has been coupled to the reusable device part for use), a controller 22 initiates heating of a consumable part or a region thereof to generate aerosol from aerosol generating material comprised in the consumable part. The controller is further configured to stop providing power to a heater to heat the consumable once a heating end condition is met, the heating end condition being based on a parameter associated with an amount of user inhalation on the consumable part.

Whilst the controller 22 is providing power to the heater to cause aerosol to be generated from the consumable part, a parameter associated with an amount of user inhalation on the consumable part is monitored by the controller. As set out further herein, the parameter may be a temperature of heater (as determined by a dedicated temperature sensor, or using a temperature coefficient of resistance (TCR) characteristic of the heater to infer the heater temperature based on heater resistance, or a temperature of a consumable (as determined by a temperature sensor). The parameter may be a level of power provided to a heater, for example, a level of power required to maintain a target temperature or set-point temperature (Tₛₑₜ). Parameters comprising temperature measurements are associated with user inhalation on the basis that the rate of cooling of a heater and/or consumable part is a function of airflow through the device/consumable part. Thus, where the airflow rate is higher, the rate of cooling of the consumable/heater may generally be higher. The parameter associated with an amount of user inhalation on the consumable part may be a rate of airflow as determined by an airflow sensor such as a pressure sensor, microphone, or hot-wire anemometer, as described further herein.

Without wishing to be bound by any particular theory, the inventors have recognised that the rate of user inhalation on a consumable part comprising aerosol generating material may be generally related to the rate of depletion of aerosol generating material in the consumable part. Thus, where a user inhales more heavily and/or for longer puffs during a session of use of a consumable part comprising a plurality of puffs, the consumable part may generally become exhausted more quickly (e.g. in terms of the supply of aerosol generating material being depleted) than if a user inhales less heavily and/or for shorter puffs during a session of use on the consumable. Thus by taking into account a parameter associated with an amount of user inhalation on a consumable part during a session, the heating duration can be dynamically adjusted to account for the rate of depletion of the consumable part during the session, as inferred based on the parameter associated with an amount of user inhalation on a consumable.

Thus, in some embodiments of the present disclosure, the controller is configured to integrate the parameter associated with an amount of user inhalation on the consumable part over time following initiation of heating of the consumable part, and to stop heating the consumable part when the integral of the parameter reaches a predefined threshold. The parameter may be integrated according to any suitable approach known to the skilled person. For example, where the controller 22 runs at a given clock speed, the value of the parameter associated with an amount of user inhalation may be measured each clock cycle (or every jth clock cycle, where j is an integer number of clock cycles) with the integral of the parameter over time being calculated as a function of the difference in the parameter between subsequent measurements, and the elapsed time between said measurements, using, for example, the trapezoid rule for estimating definite integrals. In these embodiments, during each clock cycle (or each jth clock cycle), the controller 22 compares the integral of the parameter associated with an amount of user inhalation over the elapsed heating duration (i.e. by summing the integral calculated each clock cycle since heating was initiated) with the predefined threshold value, and if the integral exceeds the predefined threshold value, the controller 22 stops supplying power to a heater to heat the consumable part.

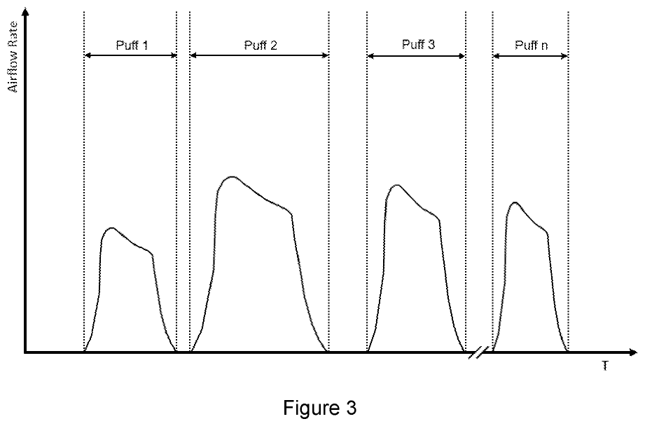

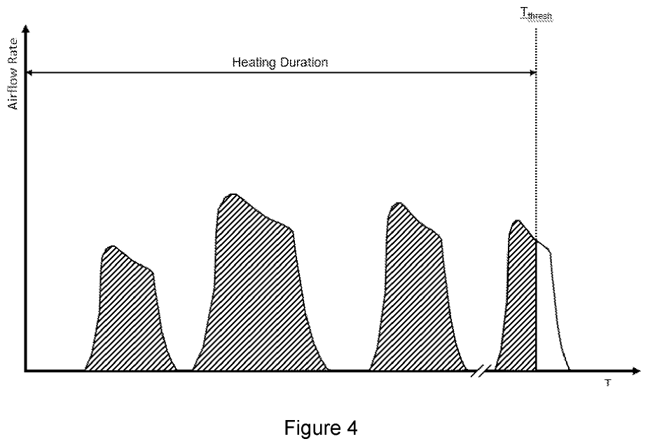

FIG. 3 shows schematically a sequence of n puffs over time, comprising a session of n puffs. The Y axis shows a parameter associated with an amount of user inhalation on the consumable part over a plurality of puffs, the parameter in this example comprising an airflow rate through the consumable part/aerosol delivery system as established based on the controller monitoring the output of an airflow sensor during the session. In this example, it is assumed heating of the consumable part is initiated at T=0 (i.e. at the intersection of X and Y axes). During each puff, the airflow rate rises and falls, and between puffs the airflow rate is zero. FIG. 4 will be recognised from FIG. 3, and schematically shows the same session of n puffs, with the integral of the airflow rate over the heating duration indicated by the hatched area under the airflow rate profile. At a time corresponding to T=Tₜₕᵣₑₛₕ, the controller determines that the integral of the parameter associated with an amount of user inhalation (i.e. the integral of the airflow rate over time) has reached/exceeded the predefined threshold, and stops supplying power to the heater to generate aerosol from the consumable part. In the example shown in FIG. 4, Tₜₕᵣₑₛₕ falls during a user puff. In some embodiments, the controller is configured to stop providing power to heat the consumable part only after a puff during which Tₜₕᵣₑₛₕ falls has concluded (as determined for example by the output of the airflow sensor falling below a threshold value), in order to avoid a detrimental experience for a user, whereby aerosol generation ceases whilst the user is taking a puff.

The controller 22 may establish the predefined threshold of integrated user inhalation parameter in a number of different ways. For example, the reusable device part 2 of the aerosol delivery system may comprise circuitry configured to receive an identifier from the consumable part when the consumable part is received in the reusable device part, wherein the identifier directly encodes a value for the threshold, or comprises an identifier which the controller 22 can cross-reference with a table (e.g. a look-up table) or other data structure in order to identify a suitable value for the threshold. The identifier may comprise an optically readable identifier (e.g. a QR code or bar-code) printed on an external surface of the consumable device part, which is read by an optical sensor coupled to controller 22, and positioned such that when the consumable part is received in the reusable device part, the identifier is proximate the optical sensor. The optical sensor may comprise a light source to illuminate the identifier to capture an image of the identifier. Alternatively, the consumable part may comprise a radio-frequency identification, RFID, tag, or near-field communication, NFC, tag, comprised in or on the consumable part, with an RFID or NFC reader module positioned in the reusable device part, and connected to the controller, to read data comprising the identifier from the RFID or NFC tag when the consumable part is received in the reusable device part. In other examples, the user may input a threshold value or select one of a predefined set of threshold values using a user input interface of the aerosol delivery device or an associated electronic device (e.g. by selecting a threshold value via an application (APP) running on a smartphone with a data connection link to the controller 22 of the aerosol delivery system). In other examples, the predefined threshold is established for the controller 22 in manufacture and represents a default value used regardless of the consumable part received in and heated by the aerosol delivery system.

The predefined threshold (or plurality of predefined thresholds which may be selected on the basis of an identifier associated with a given consumable part or selected via user input) may be established on the basis of experimentation or modelling, or by analysis of prior usage of the aerosol delivery system by a user. For example, the threshold to use for a given consumable part may be established based on a characteristic value of the integral of the parameter associated with an amount of user inhalation which is required to exhaust a consumable part of the same type as a consumable part received in the device. Thus in a laboratory setting, different consumable parts of a first type may be heated by an aerosol delivery system according to the current disclosure, using a standard power delivery profile (e.g. a constant power delivered to the heater, or a predefined time-varying heating profile delivered to the heater), with different sample consumable parts of the first type being subjected to different total values of integrated airflow through the consumable part during the heating profile, before being analysed to determine how much aerosol generating material remains for aerosolisation in the consumable part. An appropriate predefined threshold of integrated airflow to use may be determined based on an amount of integrated airflow which is established to correspond to characteristic depletion of, for example, at least 50%, at least 60%, at least 70%, at least 80%, at least 90%, at least 95%, or at least 99% of the aerosol generating material in the consumable part (as determined, for example, by quantifying the amount of aerosol generated over time by the consumable part whilst being heated, such that 100% depletion of the aerosol generating material is assumed to have occurred when aerosol is no longer generated, or the rate of aerosol generation falls below a threshold, or when above a threshold of unwanted byproducts of heating are determined to be produced).

In other contexts, the controller 22 may ‘learn’ an appropriate threshold of integrated airflow rate to use by receiving user input (for example via a button) from a user. For example, the user may train the controller 22 to use an appropriate threshold by using one or more ‘training’ heating cycles, wherein a supply of power to a heater is initiated to generate aerosol from a consumable part, and the user provides a user input (e.g. a button press) to indicate to the controller when they consider the consumable has been depleted and should no longer be heated (e.g. because an amount and/or quality of aerosol has reduced). The controller may integrate the airflow rate (or other parameter associated with the amount of user inhalation as described herein) over the heating duration following initiation of heating, up to the point at which the user provides the user input to indicate the consumable is depleted. The integral of the airflow rate at the point at which the user provides this input may be saved by the controller 22 and used subsequently as a predefined threshold to stop supply of power to the heater in subsequent heating periods/sessions.

In some embodiments of the disclosure, the controller may apply a scheme whereby two conditions are usable by the controller 22 to stop heating, one being based on an integrated parameter associated with an amount of user inhalation on the consumable as described further herein, and the other being based on elapsed time since initiation of heating. Thus in some embodiments, a threshold of elapsed heating time may be imposed by the controller following initiation of heating, such that if the threshold is met, the controller stops supplying power to the heater, even if the integral of the parameter associated with an amount of user inhalation on the consumable has not reached the predefined threshold. The threshold of elapsed heating time may be determined based on experimentation, and may be, in some examples, correspond to an amount of time taken to deplete a consumable part using a given power delivery profile used to heat the consumable part by the aerosol delivery system, whereby the time is the time taken to deplete the consumable part in the absence of any airflow through the system (and where depletion/exhaustion of the consumable part is defined as described herein).

In other embodiments of the present disclosure, the parameter associated with an amount of user inhalation on the consumable part comprises a temperature associated with the consumable part or heater, as determined based on controller 22 monitoring the output of a temperature sensor during heating of the consumable as described further herein. Where a temperature is used as the parameter associated with an amount of user inhalation on the consumable part, the control of heating duration on the basis of the parameter associated with an amount of user inhalation on the consumable part may be carried out in the same manner as described for embodiments where the parameter associated with an amount of user inhalation on the consumable part is based on the output of an airflow sensor, with the following optional modifications.

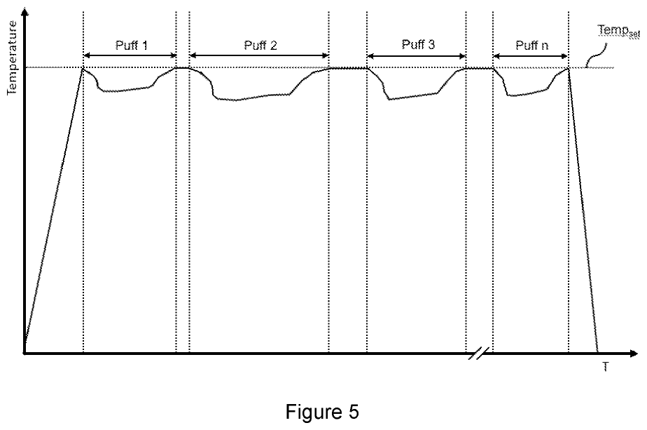

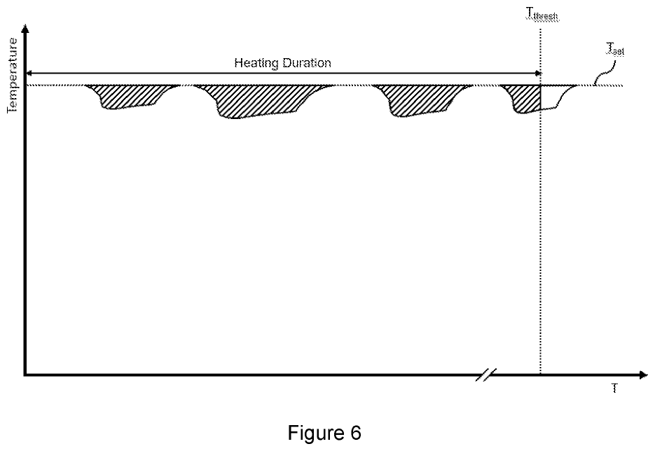

FIG. 5 will be recognised from FIGS. 3 and 4, and shows a time series of puffs with the same timings as the puffs of FIGS. 3 and 4. However, in the FIG. 5 example, the parameter associated with an amount of user inhalation on the consumable part comprises a temperature associated with the consumable part or a heater used to heat the consumable part. In this example, a fixed level of power is supplied to the heater, causing the temperature of the heater/consumable to rise to a predefined steady-state heating temperature Tempₛₑₜ, as indicated by the rising temperature profile to the left hand side of the first puff, ‘puff 1’ (though the specific heating profile is not significant). Because the level of power supplied to the heater is constant, the temperature of the heater in this example varies as a function of the amount of user inhalation (e.g. the airflow rate). Thus the difference between the actual temperature of the heater/consumable during heating is indicative of an amount of user inhalation. This is shown schematically in FIG. 5, wherein during each of the n puffs, the temperature of the heater/consumable drops from the steady-state value in the absence of airflow (e.g. Tempₛₑₜ), to a reduced value, where the reduction in temperature is proportional to the rate of cooling (i.e. to the rate of airflow through/over the consumable part). FIG. 6 will be recognised from FIG. 5, and schematically shows using hatching a difference between the integral of the steady state value of heater/consumable temperature in the absence of airflow (i.e. the integral of Tempₛₑₜ) and the integral of the actual temperature of the heater/consumable as determined by temperature measurement of the heater and/or consumable using approaches set out herein. As in the embodiments described in relation to FIGS. 3 and 4, at a time T=Tₜₕᵣₑₛₕ, the controller 22 determines that an integral of a parameter associated with an amount of user inhalation on the consumable part (in this instance comprising a temperature parameter, and the integral being a difference between integrals of actual temperature and a steady state temperature Tempₛₑₜ) has reached a predefined threshold, and determines to stop a supply of power to the heater of the aerosol delivery system. As described further herein, the supply of power may be stopped during the puff in which Tₜₕᵣₑₛₕ falls, or the puff may be allowed to finish (e.g. as determined based on the temperature of the heater returning to Tempₛₑₜ) before the supply of power is stopped.

A suitable value to use for the predefined threshold may be established as already described in relation to embodiments wherein the parameter associated with an amount of user inhalation on the consumable part is an airflow rate, and may accordingly be established in a controlled laboratory environment, based on known depletion characteristics of consumable parts, or established by a user training the controller 22 of the aerosol delivery system as described further herein (e.g. by a user providing an input when a consumable part is determined to be depleted, and using the corresponding difference in the integrals of the actual heater/consumable temperature and Tempₛₑₜ at the point the user input is provided as the predefined threshold for a future heating cycle). The value of Tempₛₑₜ may be constant, or may vary with time, and represents the temperature of the heater/consumable part under heater control characteristics used by the controller (e.g. fixed or time-varying power) under conditions of no airflow through the consumable part/aerosol delivery system (e.g. the steady state temperature when there is no air cooling due to mass flow of air through the consumable). Tempₛₑₜ may be established by the skilled person based on experiments or modelling, and may be time varying.

In other embodiments, the heater power may be controlled based on determining a set-point of temperature (Tₛₑₜ) and supplying a varying level of power to the heater to seek to maintain the set point during the heating duration of the consumable part (for example, using pulse-width modulation approaches known to the skilled person). In such examples, the temperature may not vary with airflow (though there may be a slight drop in temperature before the heater temperature increases to compensate for the cooling effect), but the power delivered to the heater to maintain the set-point of temperature will increase as the rate of cooling of the heater/consumable increases due to increased user inhalation on the consumable. Thus the amount of power delivered to the heater to maintain the set-point of temperature may in such embodiments be used as the parameter associated with an amount of user inhalation on the consumable part, and may be integrated to determine when to stop heating based on comparing the integrated power to a predefined threshold as described further herein. A suitable value of the predefined threshold may be established in a controlled laboratory environment, based on known depletion characteristics of consumable parts as described further herein, or established by a user training the controller 22 of the aerosol delivery system as described further herein (e.g. by a user providing an input when a consumable part is determined to be depleted), and using the integrated power delivered to the heater at the point the user input is provided as the value of the predefined threshold.

Thus embodiments have been described in which a value of the total heating duration for a consumable part is not fixed or otherwise defined in advance of initiating heating, but is a function of the integral of the parameter associated with the amount of user inhalation.

In other embodiments of the disclosure, the controller 22 stops heating the consumable part based on determining an elapsed duration of time since initiation of heating of the consumable part. This elapsed time may be modified during heating on the basis of monitoring the parameter associated with an amount of user inhalation, and optionally comparing the parameter to a control parameter.

Thus, according to some embodiments of the disclosure, a controller is configured to establish, prior to initiating heating of a consumable part, an initially defined value of a heating duration for the consumable part, to adjust the heating duration from the initially defined value, during heating of the consumable part, based on a parameter associated with the amount of user inhalation on the consumable part, and to stop heating the consumable part after the adjusted heating duration has elapsed from initiating heating of the consumable part.

In some embodiments of the disclosure, the controller is configured to determine during heating of a consumable part a remaining heating duration for the consumable part, based on an initially defined value of the heating duration, and the time elapsed since initiating heating of the consumable part; to compare a parameter associated with an amount of user inhalation, as described herein, with a control parameter, and if the value of the parameter associated with an amount of user inhalation on the consumable is greater than the value of the control parameter, to reduce the remaining heating duration for the consumable part, or if the value of the parameter associated with an amount of user inhalation on the consumable is less than the value of the control parameter, to increase a remaining heating duration for the consumable part, to obtain an adjusted remaining heating duration; and stop supplying power to the heater when the adjusted remaining heating duration has elapsed.

The initially defined (i.e. predefined) value of the heating duration may be established for a consumable part based on a characteristic period of time taken to deplete/exhaust the a consumable part of the given type based on a heating profile used by the aerosol delivery system to supply heat to a consumable part during a session comprising a plurality of puffs. The characteristic period of time may be established based on a time taken to deplete the consumable part based on an average user puff frequency, duration, and draw strength. This may be based on experimental data collected for a plurality of users, or based on characteristic session behaviour (in terms of average user puff frequency, duration, and draw strength) of a specific user of the aerosol delivery system. Thus consumable parts as provided for use with an aerosol delivery system according to the present disclosure may each be associated with a predefined/initially-defined heating duration. This duration may be set in the controller 22 in manufacture (e.g. where the aerosol delivery system is configured to use a single type of consumable part) or an initially defined heating duration may be set individually for different consumable parts, for example by encoding the initially defined heating duration in a consumable part identifier (e.g. a QR code, RFID or NFC tag) as described herein, and receiving the initially defined heating duration at the controller 22 when a consumable part is coupled to the aerosol delivery system for use. (or looking it up in a table or other data structure using a unique identifier associated with the consumable part). Thus the controller 22 may establish an appropriate initially defined heating duration to use for a consumable part in a similar manner to that described for establishing an appropriate predefined threshold value in other embodiments herein. In other examples, the initially defined heating duration may be determined by the controller 22 based on previous usage information, for example, based on an average heating duration of a plurality of previous sessions, or may be manually input by a user, via a user input interface.

In embodiments of the present disclosure, a control parameter may be determined, which in some cases comprises an average value of the parameter associated with an amount of user inhalation on a consumable part over a heating duration, as determined on the basis of experimentation or analysis of previous usage of the aerosol delivery device by a user. In some embodiments, this heating duration used to determine the control parameter corresponds to the initially defined heating duration as described further herein. In some embodiments, the heating duration is a characteristic heating duration taken for the consumable part to be depleted/exhausted, as determined according to approaches for determining depletion/exhaustion of a consumable part as described further herein. Thus the control parameter may represent the average value of a parameter associated with an amount of user inhalation on the consumable part over a plurality of puffs (e.g. an average airflow rate, average temperature, or average power), over a characteristic time taken to deplete the consumable part given said amount of user inhalation over said plurality of puffs, and may comprise an average taken over many sessions on many consumable parts.

According to embodiments of the disclosure, the controller is configured to compare, over an integrating time shorter than the initially defined value of the heating duration, an integral of the parameter associated with an amount of user inhalation on the consumable, with an integral of a control parameter, and if the integral of the parameter associated with an amount of user inhalation on the consumable is greater than the integral of the control parameter, to reduce the heating duration from the initially defined value (or from a previously modified heating duration computed based on a determination made in a previous integrating time); or if the integral of the parameter associated with an amount of user inhalation on the consumable is less than the integral of the control parameter, to increase the heating duration from the initially defined value (or from a previously modified heating duration computed based on a determination made in a previous integrating time). Generally, the controller in such embodiments is configured to increase or reduce the remaining heating duration so that an integral of the control parameter over the increased or reduced remaining duration is increased or reduced by an amount proportional to the difference between the integral of the parameter associated with an amount of user inhalation on the consumable over the integrating time and the integral of the control parameter over the integrating time.

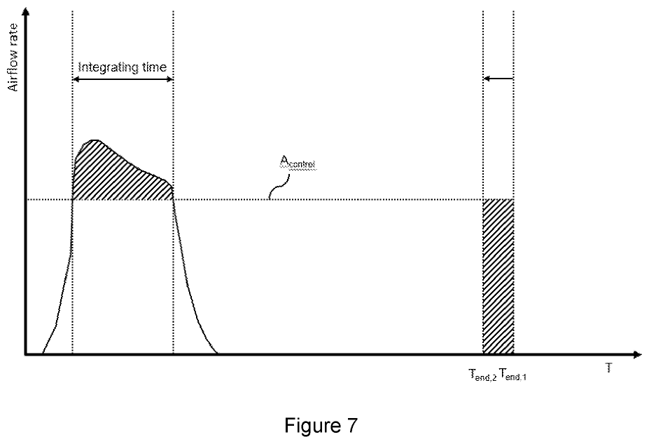

FIG. 7 schematically shows an example of the scheme described above, in which a value of the initially defined heating duration, set prior to initiating heating, is the duration extending from T=0 to an initially defined end time ‘T_{end,1}’. Heating of the consumable part is initiated at T=0 (e.g. at the intersection of X and Y axes), and the controller begins to count elapsed time since initiation of heating, with the condition for stopping heating being the elapsed time reaching the pre-defined end time T_{end,1}. Over an integrating time (schematically shown in FIG. 7), the controller integrates both (i) the value of a parameter associated with an amount of user inhalation on the consumable (which in this example is airflow rate, but could be any parameter associated with an amount of user inhalation on the consumable described herein), and (ii) a control parameter as described further herein (shown here as A_{control}), and computes the difference between these two integrals. This difference is shown schematically as a hatched region of the airflow profile over the integrating time. In this instance, the integral of the actual airflow rate is higher than the integral of the control parameter for airflow rate, and accordingly the remaining duration of heating (i.e. the time until the controller will stop supplying power to the heater) is reduced so that the original end time T_{end,1} is updated to a new end time T_{end,2}, wherein T_{end,2} is selected such that the integral of A_{control} over the period T_{end,2} and T_{end,1} is equal to the difference between the integral of the parameter associated with an amount of user inhalation on the consumable and the integral of the control parameter, over the integrating time. This procedure may be followed every clock cycle or every j clock cycles of the controller, with the remaining duration of heating thus being dynamically adjusted during heating. In some embodiments, the heating duration may be extended if the integral of the parameter associated with an amount of user inhalation on the consumable is lower than the integral of the control parameter. Such schemes which take into account an initially defined heating duration, and then allow this to be adjusted on the basis of characteristics of user inhalation during heating, may be considered advantageous because they allow previously determined information about a characteristic heating duration to depletion of a given type of consumable part to be used to determine how to heat consumable parts of this type (e.g. the consumable part may characteristically have a heating duration of 1, 2, 3, 4, 5, or 6 minutes, or any other suitable duration depending on the properties of the consumable part), but then allow this time to be adjusted in the event user inhalation characteristics deviate from the characteristic/estimated pattern of user inhalation on which the predefined duration is based (i.e. deviate from an ‘average’ usage pattern). The amount by which the predefined duration can be increased or decreased according to approaches set out herein may be limited by the controller to a certain percentage of the predefined duration (e.g. 1%, 5%, 10%, 15%, 20%, 30%, 40%, or 50% of the predefined duration) above and/or below the predefined duration (i.e. it may only be possible to extend, or only possible to decrease, the duration during heating, or it may be possible to extend or decrease the duration). Once a limit of adjustment above or below the predefined duration is reached, the controller may no permit further adjustment beyond the limit, regardless of airflow through the consumable part.

In embodiments of the disclosure, information relating to a characteristic/average pattern of usage by the user for a consumable part may be indicated to the user. As described further herein, information about a characteristic number of puffs available to a user from a given type of consumable part may be predefined in manufacture, or may be derived from monitoring of usage of the aerosol delivery system (e.g. in terms of puff frequency, puff duration, draw strength, and the number of puffs characteristically obtained from a consumable part of the given type before the consumable part is exhausted). Such monitoring may be carried out for a single user of a specific aerosol delivery system, or for a plurality of users by collecting information from a plurality of aerosol delivery systems. Data obtained from monitoring usage behaviour of one or more users may be used to determine one or more indications to provide to a user (via, for example, a display on the aerosol delivery system, via an app on a computing device (e.g. a smartphone) having a data connection to the aerosol delivery system, or by a haptic or audible indication provided by either the aerosol delivery system or a connected computing device). For example, where monitoring of usage provides information relating to the average number of puffs available to a user from a given type of consumable (determined, for example, as an average number of puffs available for each discrete consumable part, as calculated over multiple consumable parts by one or a plurality of users), this information may be indicated to a user via a visual, haptic, or audible indication. This information may be queried by the user, or may be automatically provided in response to a trigger, such as for example the insertion of an unused consumable part into the aerosol delivery system.

In the embodiments described herein, reference has been made to providing power to a heater to generate aerosol from a consumable part. It will be appreciated that in embodiments of the disclosure, a consumable part may comprise a plurality of different regions which can be selectively heated to generate aerosol by a plurality of heaters, or by different heating regions of a single heater. In such embodiments, the control scheme set out herein, wherein heating is initiated, and stopped after an elapsed duration from initiation, where the duration is dependent on a parameter associated with an amount of user inhalation on the consumable, may be applied separately, and either sequentially or in parallel, in respect of each of a plurality of regions of a consumable, for example, first and second selectively heatable regions. Thus in some embodiments, the controller may be configured to initiate heating of a first region of the consumable part; monitor, during heating of the first region of the consumable part, a parameter associated with an amount of user inhalation on the consumable part over a plurality of puffs; stop heating the first region of the consumable part based on the parameter associated with an amount of user inhalation; initiate heating of a second region of the consumable part; monitor, during heating of the second region of the consumable part, a parameter associated with an amount of user inhalation on the consumable part over a plurality of puffs; and stop heating the second region of the consumable part based on the parameter associated with an amount of user inhalation.

Thus there has been described an aerosol delivery system configured to heat a consumable part to generate an aerosol, the aerosol delivery system comprising a controller configured to: initiate heating of the consumable part; monitor, during heating of the consumable part, a parameter associated with an amount of user inhalation on the consumable part over a plurality of puffs; and stop heating the consumable part based on the parameter associated with an amount of user inhalation.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol delivery system configured to heat a consumable part to generate an aerosol, the aerosol delivery system comprising a controller configured to:
initiate heating of the consumable part;
monitor, during heating of the consumable part, a parameter associated with an amount of user inhalation on the consumable part over a plurality of puffs; and
stop heating the consumable part based on the parameter associated with an amount of user inhalation.

2. The aerosol delivery system of claim 1, wherein the monitored parameter comprises a continuous parameter.

3. The aerosol delivery system of claim 2, wherein the monitored parameter comprises a temperature associated with heating of the consumable part.

4. The aerosol delivery system of claim 3, wherein the aerosol delivery system comprises a heater, and the temperature comprises a temperature of the heater.

5. (canceled)

6. The aerosol delivery system of either of claims 1, wherein the parameter comprises a level of power used to heat the consumable part.

7. The aerosol delivery system of claim 3, wherein the aerosol delivery system comprises a temperature sensor configured to measure a temperature of the consumable part, and the parameter comprises a temperature of the consumable part measured by the sensor.

8. The aerosol delivery system of claim 2, wherein the device comprises an airflow sensor configured to measure airflow through the consumable part, and the parameter comprises a rate of airflow through the consumable part measured by the airflow sensor.

9. The aerosol delivery system of claim 2, wherein the device comprises an airflow sensor configured to detect airflow through the consumable part, and the parameter comprises the cumulative duration of airflow through the consumable part as measured by the airflow sensor since initiation of heating of the consumable part.

10. (canceled)

11. (canceled)

12. The aerosol delivery system of claim 1, wherein the controller is configured to compare the parameter associated with an amount of user inhalation with a control parameter; and
if the value of the parameter associated with an amount of user inhalation on the consumable part is greater than the value of the control parameter, to reduce a remaining heating duration for the consumable part,
wherein the controller is configured to stop heating the consumable part when the remaining heating duration has elapsed.

13. The aerosol delivery system of claim 1, wherein the controller is configured to compare the parameter associated with an amount of user inhalation with a control parameter; and
if the value of the parameter associated with an amount of user inhalation on the consumable part is less than the value of the control parameter, to increase a remaining heating duration for the consumable part;
wherein the controller is configured to stop heating the consumable part when the remaining heating duration has elapsed.

14. The aerosol delivery system of claim 1, wherein the controller is configured to integrate the parameter over time, and stop heating the consumable part when the integral of the parameter reaches a predefined threshold.

15. The aerosol delivery system of claim 12, wherein the value of the predefined threshold or control parameter is established for a given consumable part based on identifying information associated with the consumable part.

16. The aerosol delivery system of claim 12, wherein the value of the predefined threshold or control parameter is established based on user input to a user input interface associated with the aerosol delivery system.

17. The aerosol delivery system of claim 12, wherein the threshold is established based on a characteristic value of the integral of the parameter associated with an amount of user inhalation which is required to exhaust the consumable part.

18. The aerosol delivery system of claim 1, wherein the controller is configured to:
stop heating the consumable part after a heating duration has elapsed from initiating heating of the consumable part;
establish, prior to initiating heating of the consumable part, an initially defined value of the heating duration;
adjust the heating duration from the initially defined value, during heating of the consumable part, based on the parameter associated with the amount of user inhalation on the consumable part.

19-24. (canceled)

25. The aerosol delivery system of claim 12, wherein the control parameter comprises an average value of the parameter associated with an amount of user inhalation on the consumable part over a characteristic heating duration in which the component part is exhausted.

26. (canceled)

27. (canceled)

28. The aerosol delivery system of claim 1, configured to selectively heat a plurality of different regions of the consumable part, and wherein the controller is configured to:
initiate heating of a first region of the consumable part;
monitor, during heating of the first region of the consumable part, a parameter associated with an amount of user inhalation on the consumable part over a plurality of puffs; and
stop heating the first region of the consumable part based on the parameter associated with an amount of user inhalation;
initiate heating of a second region of the consumable part;
monitor, during heating of the second region of the consumable part, a parameter associated with an amount of user inhalation on the consumable part over a plurality of puffs; and
stop heating the second region of the consumable part based on the parameter associated with an amount of user inhalation.

29. (canceled)

30. An aerosol delivery device configured to heat a consumable part to generate an aerosol, the aerosol delivery device comprising a controller configured to:
initiate heating of the consumable part;
monitor, during heating of the consumable part, a parameter associated with an amount of user inhalation on the consumable part over a plurality of puffs; and
stop heating the consumable part based on the parameter associated with an amount of user inhalation.

31. A method of controlling an aerosol delivery system, comprising a controller, to heat a consumable part to generate an aerosol, the method comprising operating the controller to carry out the steps of:
initiating heating of the consumable part;
monitoring, during heating of the consumable part, a parameter associated with an amount of user inhalation on the consumable part over a plurality of puffs; and
stopping heating the consumable part when the parameter reaches a threshold.

32. (canceled)
